(19) United States
(12) Patent Application Publication
(10) Pub. No.: US 2017/0093226 A1
(43) Pub. Date: Mar. 30, 2017

(54) METHODS AND CIRCUITS FOR MONITORING AND REGULATING VOLTAGE ACROSS A LOW VOLTAGE DEVICE DRIVEN BY A LONG LINE CARRYING RADIO FREQUENCY SIGNALS

(71) Applicant: Signalchip Innovations Private Limited, Bangalore (IN)

(72) Inventors: Himamshu Gopalakrishna Khasnis, Bengaluru (IN); Anantha Melavarige Subraya, Shimoga (IN)

(21) Appl. No.: 15/274,002

(22) Filed: Sep. 23, 2016

(30) Foreign Application Priority Data
Sep. 24, 2015 (IN) 5114/CHE/2015

(51) Int. Cl. H02J 50/20; H02M 7/04

(52) U.S. Cl. CPC H02J 50/20; H02M 7/04

(57) ABSTRACT

A circuit for regulating a voltage of a high radio frequency line across a low voltage device 112 is provided. The circuit includes an input port, a high radio frequency line, a LC circuit, a peak detection circuit 108, a comparator 110, and a variable resistor 106. The input port receives a high radio frequency signal. The high radio frequency line carries the high radio frequency signal. The LC circuit boosts the high radio frequency line into a boosted high radio frequency line. The peak detection circuit 108 measures a voltage of the boosted high radio frequency line, and detects a peak of the voltage of the boosted high radio frequency line. The comparator 110 compares the voltage with a pre-defined voltage 114. The variable resistor 106 regulates the voltage of the boosted high radio frequency line based on an output of the comparator 110.

### CROSS-REFERENCE TO RELATED APPLICATIONS

This application claims priority to Indian patent application no. 5114/CHE/2015 filed on Sep. 24, 2015, the complete disclosure of which, in its entirely, is herein incorporated by reference.

### BACKGROUND

Technical Field

The embodiments herein generally relate to voltage regulation, and more particularly, to a circuit and a method for regulating voltage of a high radio frequency line of a radio frequency circuit for the protection of devices that are driven by the high radio frequency line in integrated circuits.

Description of the Related Art

In communication systems, transmission line is configured to carry alternating current of a radio frequency that includes signals with a high radio frequency. Typically, the transmission lines are used for purposes such as connecting a radio transmitter and a radio receiver with their antenna, distributing cable television signals, routing calls between telephone switching centers, computer network connections and high speed computer data buses and the like. However, inside integrated circuits (ICs), distances between source and destination of the radio frequency signals are typically much lower than wavelength of the radio frequency signals. In such cases, a lumped model of interconnect consisting of series inductor and a shunt load capacitor describes the behavior of interconnect accurately. In such interconnects, when the frequency of an input signal is close to resonant frequency of a LC network, gain of the circuit is very large. During such instances, the interconnect produces an amplified version of the input signal at output, which may not desirable in cases where the output of the interconnect feeds circuits that have devices voltage rating at their inputs.

Accordingly, there remains a need for a system and a method to monitor and regulate voltage across a low voltage device driven by a long line carrying radio frequency signals in integrated circuits.

### SUMMARY

In view of a foregoing, an embodiment herein provides a circuit for regulating a voltage of a high radio frequency line across a low voltage device. The circuit includes an input port, a high radio frequency line, a LC circuit, a peak detection circuit, a comparator, and a variable resistor. The input port receives a high radio frequency signal. The high radio frequency line is configured to carry the high radio frequency signal from the input port. The LC circuit is configured to boost the high radio frequency line into a boosted high radio frequency line. The peak detection circuit is configured to (i) measure a voltage of the boosted high radio frequency line, and (ii) detect a peak of the voltage of the boosted high radio frequency line. The comparator is configured to compare the voltage of the boosted high radio frequency line with a pre-defined voltage. The variable resistor is configured to control quality factor of the circuit to gain voltage. The variable resistor regulates the voltage of the boosted high radio frequency line to equal to the pre-defined voltage by adjusting a resistance of the variable resistor based on an output of the comparator.

In an embodiment, the LC circuit includes an inductor, and a capacitor. The inductor is configured to model an inductance of the high radio frequency line. The capacitor is configured to model a capacitance of the high radio frequency line to obtain the boosted high radio frequency line.

In another embodiment, the voltage that is regulated is applied to the low voltage device.

In yet another embodiment, the comparator identifies a voltage variation between the pre-defined voltage and the voltage of the boosted high radio frequency line.

In yet another embodiment, the variable resistor is placed in series with the high radio frequency line.

In one aspect, a circuit for regulating a voltage of a high radio frequency line across a low voltage device is provided. The circuit includes an input port, a high radio frequency line, a LC circuit, a peak detection circuit, a comparator, and a variable resistor. The input port receives a high radio frequency signal. The high radio frequency line is configured to carry the high radio frequency signal from the input port. The LC circuit is configured to boost the high radio frequency line into a boosted high radio frequency line. The LC circuit includes an inductor, and a capacitor. The inductor is configured to model an inductance of the high radio frequency line. The capacitor is configured to model a capacitance of the high radio frequency line to obtain the boosted high radio frequency line.

The peak detection circuit is configured to (i) measure a voltage of the boosted high radio frequency line, and (ii) detect a peak of the voltage of the boosted high radio frequency line. The comparator is configured to compare the voltage of the boosted high radio frequency line with a pre-defined voltage. The comparator identifies a voltage variation between the pre-defined voltage and the voltage of the boosted high radio frequency line. The variable resistor is configured to control quality factor of the circuit to gain voltage. The variable resistor regulates the voltage of the boosted high radio frequency line to equal to the pre-defined voltage by adjusting a resistance of the variable resistor based on the voltage variation identified by the comparator. The voltage is regulated is applied to the low voltage device. The variable resistor is placed in series with the high radio frequency line.

In an embodiment, the resistance of the variable resistor that is required to regulate the voltage of the high radio frequency line is determined based on a known input frequency of the high radio frequency line.

In another embodiment, the resistance of the variable resistor is selected from a look up table. The look up table may be generated during an initial calibration based on a known input frequency.

In yet another embodiment, the variable resistor is placed in series with the inductor.

In another aspect, a method for regulating a voltage of a high radio frequency line across a low voltage device is provided. The method includes the following steps: (a) applying a high radio frequency signal to an input port of a high radio frequency line, wherein the high radio frequency is configured to carry the high radio frequency signal; (b) boosting, using a LC circuit, the high radio frequency line into a boosted high radio frequency line; (c) measuring, using a peak detection circuit, a voltage of the boosted high radio frequency line; (d) detecting, using the peak detection circuit, a peak of the voltage of the boosted high radio frequency line; (e) comparing, using a comparator, the voltage of the boosted high radio frequency line with a pre-defined voltage; (f) regulating, using a variable resistor, the voltage of the boosted high radio frequency line to equal to the pre-defined voltage by adjusting a resistance of the variable resistor based on an output of the comparator; and (g) applying the voltage that is regulated to the low voltage device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a circuit for regulating a voltage of a high radio frequency line across a low voltage device according to an embodiment herein. and

FIG. 2 is a flow diagram that illustrates a method for regulating a voltage of a high radio frequency line across a low voltage device according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Various embodiments provide circuits and methods to regulate voltage across load resistor of a high radio frequency transmission line of a radio frequency (RF) circuit. More particularly, the circuits and methods disclosed herein deals with the sensing and regulation of the voltage at the output port of interconnect to protect low voltage devices connected to a port.

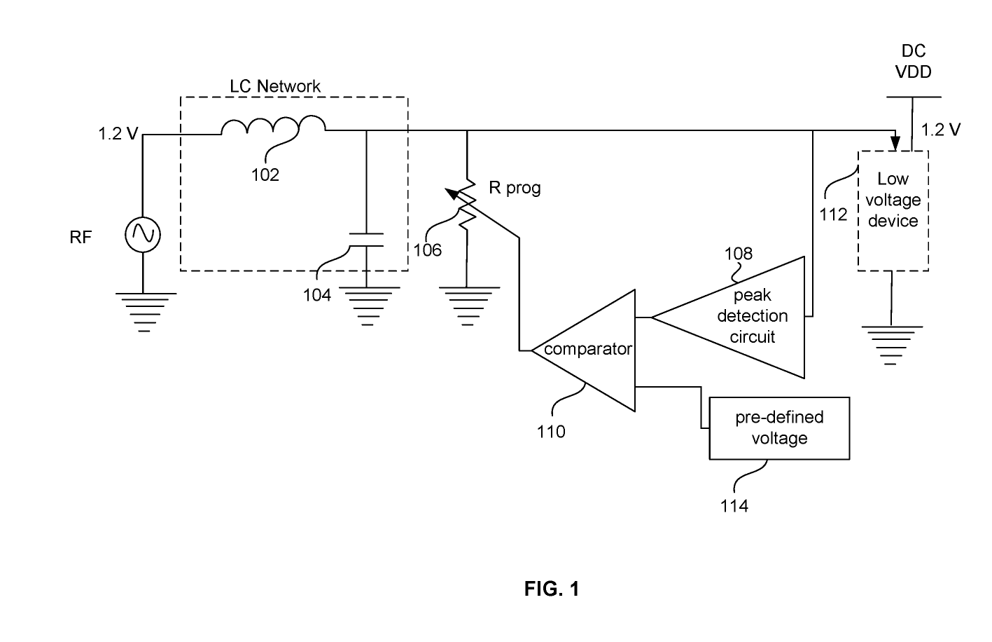

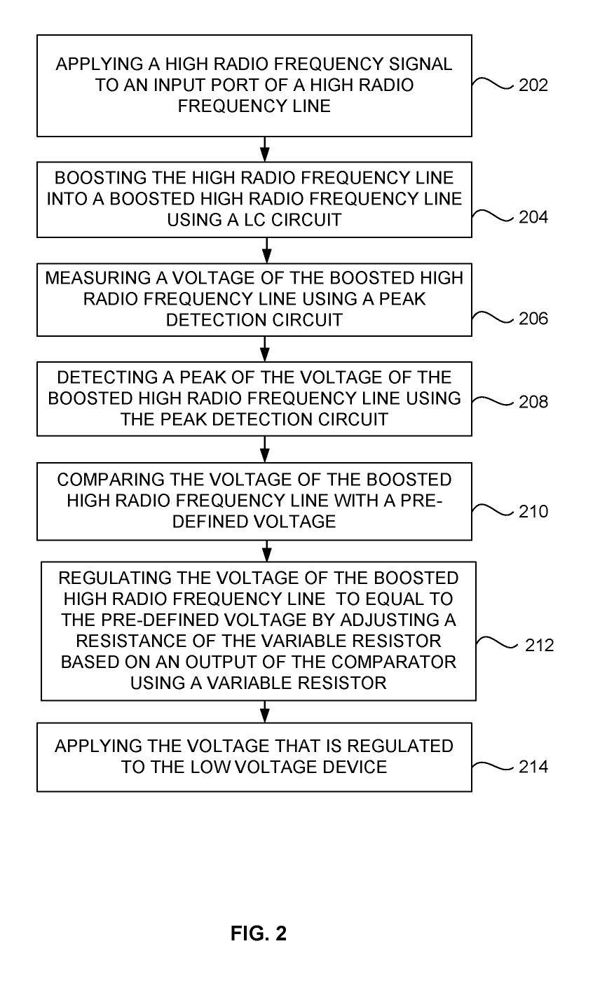

As mentioned, there remains a need for a circuit and a method to monitor and regulate voltage across a low voltage device driven by a long line carrying radio frequency signals in integrated circuits. Referring now to the drawings, and more particularly to FIGS. 1 through 2, where similar reference characters denote corresponding features consistently throughout the figures, there are shown preferred embodiments.

FIG. 1 illustrates a circuit for regulating a voltage of a high radio frequency line across a low voltage device 112 according to an embodiment herein. The circuit includes a high radio frequency line. The high radio frequency line includes an input port and an output port. The input port of the radio frequency line receives a high radio frequency signal. The high radio frequency line carries the high radio frequency signal. The circuit further includes an inductor 102, a capacitor 104 a variable resistor 106, a peak detection circuit 108, and a comparator 110. The low voltage device 112 may be driven by the high radio frequency line. An inductance of the high radio frequency line is modeled by the inductor 102. The line capacitance and the input capacitances of the circuit connecting to the high radio frequency line are modeled by the capacitor 104. The high radio frequency line may be modeled by the inductor 102 and the capacitor 104 to obtain a boosted high radio frequency line. The variable resistor 106 controls quality factor of the circuit to gain voltage from the input port of the high radio frequency line to the output port the high radio frequency line. The variable resistor 106 may be a programmable resistor (R_{prog}). The low voltage device 112 may include devices with low voltage ratings at an input port of the low voltage device 112. A voltage of the boosted high radio frequency line may be obtained at the output port of the radio frequency line due to inductance and capacitance of the high radio frequency line when the frequency of the high radio frequency signal is close to a resonant frequency of the LC circuit. The peak detection circuit 108 measures the voltage of the boosted high radio frequency line. The peak detection circuit 108 detects a peak of the voltage of the boosted high radio frequency line. The comparator 110 compares the voltage of the boosted high radio frequency line with a pre-defined voltage 114 (e.g. a voltage that is close to voltage ratings of the low voltage device 112). In one embodiment, the comparator 110 identifies voltage variation between the pre-defined voltage 114 and the voltage of the boosted high radio frequency line. The variable resistor 106 regulates the voltage of the boosted high radio frequency line to equal to the pre-defined voltage 114 by adjusting a resistance of the variable resistor 106 based on an output of the comparator 110. The output of the comparator 110 may include voltage variation between the pre-defined voltage 114 and the voltage of the boosted high radio frequency line. In another embodiment, the variable resistor 106 may be placed in series with the high radio frequency line. In this way, a safe voltage is applied to the low voltage device 112. In one embodiment, the variable resistor 106 may be placed in series with the inductor 102. The resistance that is required to regulate the voltage of high radio frequency line is determined based on an input frequency of the high radio frequency line. If the input frequency is known, the resistance of the variable resistor 106 is selected from a look up table. The look up table may be generated during an initial calibration (e.g., the resistance required for different frequencies may be found and stored in a lookup table as soon as the device is turned on). If the frequency is unknown, the circuit may be initialized to its lowest quality factor (e.g. Q factor), so that the low voltage device 112 may not get damaged during its operation.

FIG. 2 is a flow diagram that illustrates a method for regulating a voltage of a high radio frequency line across a low voltage device 112 of FIG. 1 according to an embodiment herein. At step 202, a high radio frequency signal is applied to an input port of a high radio frequency line. The high radio frequency line carries the high radio frequency signal. At step 204, the high radio frequency line is boosted to a boosted high radio frequency line using a LC circuit. At step 206, a voltage of the boosted high radio frequency line is measured using a peak detection circuit 108. In one embodiment, the voltage of the boosted high radio frequency line may be obtained at an output port of the radio frequency line due to inductance and capacitance of the high radio frequency line when the frequency of the high radio frequency signal) is close to a resonant frequency of the LC circuit. At step 208, a peak of the voltage of the boosted high radio frequency line is detected using the peak detection circuit 108. At step 210, the voltage of the boosted high radio frequency line is compared with a predefined voltage 114 (e.g. a voltage that is safe to be applied to the low voltage device 112) using a comparator 110. The predefined voltage 114 may be a voltage of the low voltage device 112.

At step 212, the voltage of the boosted high radio frequency line is regulated to equal to the pre-defined voltage 114 by adjusting a resistance of the variable resistor 106 based on an output of the comparator 110 using a variable resistor 106. The resistance of the circuit may affect quality factor (e.g. Q factor) of the circuit and reduce the gain from the input of the high radio frequency line to its output. The variable resistor 106 will adjust the resistance continuously till the voltage of the boosted high radio frequency line is equal to the pre-defined voltage 114. In one embodiment, if the voltage of the boosted high radio frequency line is higher than the pre-defined voltage 114, the variable resistor 106 decrease the resistance based on an output of the comparator 110. In another embodiment, if the voltage of the boosted high radio frequency line is lower than the pre-defined voltage 114, the variable resistor 106 increase the resistance based on the output of the comparator 110. The output of the comparator 110 may include voltage variation between the pre-defined voltage 114 and the voltage of the boosted high radio frequency line. At step 214, the voltage that is regulated is applied to the low voltage device 112.

The circuit protects the low voltage device 112 that has a low voltage rating from the voltage of the boosted high radio frequency line. The circuit regulates the voltage of the boosted high radio frequency line to equal to the pre-defined voltage 114 by varying the resistance of the variable resistor 106, thereby a regulated voltage is supplied to the low voltage device 112. The circuit is uncomplicated design compared to existing circuits.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein may be practiced with modification within the spirit and scope of the appended claims.

I/We claim:

1. A circuit for regulating a voltage of a high radio frequency line across a low voltage device (112), comprising:
an input port that receives a high radio frequency signal;
a high radio frequency line that is configured to carry the high radio frequency signal from the input port;
a LC circuit that is configured to boost the high radio frequency line into a boosted high radio frequency line;
a peak detection circuit (108) that is configured to (i) measure a voltage of the boosted high radio frequency line, and (ii) detect a peak of the voltage of the boosted high radio frequency line;
a comparator (110) that is configured to compare the voltage of the boosted high radio frequency line with a pre-defined voltage (114); and
a variable resistor (106) that is configured to control quality factor of the circuit to gain voltage, wherein the variable resistor (106) regulates the voltage of the boosted high radio frequency line to equal to the pre-defined voltage (114) by adjusting a resistance of the variable resistor (106) based on an output of the comparator (110).

2. The circuit as claimed in claim 1, the LC circuit comprising:
an inductor (102) that is configured to model an inductance of the high radio frequency line;
a capacitor (104) that is configured to model a capacitance of the high radio frequency line to obtain the boosted high radio frequency line.

3. The circuit as claimed in claim 1, wherein the voltage that is regulated is applied to the low voltage device (112).

4. The circuit as claimed in claim 1, wherein the comparator (110) identifies a voltage variation between the pre-defined voltage (114) and the voltage of the boosted high radio frequency line.

5. The circuit as claimed in claim 1, wherein the variable resistor (106) is placed in series with the high radio frequency line.

6. A circuit for regulating a voltage of a high radio frequency line across a low voltage device (112), comprising:
an input port that receives a high radio frequency signal;
a high radio frequency line that is configured to carry the high radio frequency signal from the input port;
a LC circuit that is configured to boost the high radio frequency line into a boosted high radio frequency line, wherein the LC circuit comprises:
an inductor (102) that is configured to model an inductance of the high radio frequency line;
a capacitor (104) that is configured to model a capacitance of the high radio frequency line to obtain the boosted high radio frequency line;
a peak detection circuit (108) that is configured to (i) measure a voltage of the boosted high radio frequency line, and (ii) detect a peak of the voltage of the boosted high radio frequency line;
a comparator (110) that is configured to compare the voltage of the boosted high radio frequency line with a pre-defined voltage (114), wherein the comparator (110) identifies a voltage variation between the pre-defined voltage (114) and the voltage of the boosted high radio frequency line; and
a variable resistor (106) that is configured to control quality factor of the circuit to gain voltage, wherein the variable resistor (106) regulates the voltage of the boosted high radio frequency line to equal to the pre-defined voltage (114) by adjusting a resistance of the variable resistor (106) based on the voltage variation identified by the comparator (110), wherein the voltage that is regulated is applied to the low voltage device (112), wherein the variable resistor (106) is placed in series with the high radio frequency line.

7. The circuit as claimed in claim 6, wherein the resistance of the variable resistor (106) that is required to regulate the voltage of the high radio frequency line is determined based on a known input frequency of the high radio frequency line.

8. The circuit as claimed in claim 6, wherein the resistance of the variable resistor (106) is selected from a look up table that is generated during an initial calibration based on a known input frequency.

9. The circuit as claimed in claim 6, wherein the variable resistor (106) is placed in series with the inductor (102).

10. A method for regulating a voltage of a high radio frequency line across a low voltage device (112), comprising:
applying a high radio frequency signal to an input port of a high radio frequency line, wherein the high radio frequency is configured to carry the high radio frequency signal;
boosting, using a LC circuit, the high radio frequency line into a boosted high radio frequency line;
measuring, using a peak detection circuit (108), a voltage of the boosted high radio frequency line;
detecting, using the peak detection circuit (108), a peak of the voltage of the boosted high radio frequency line;
comparing, using a comparator (110), the voltage of the boosted high radio frequency line with a pre-defined voltage (114);
regulating, using a variable resistor (106), the voltage of the boosted high radio frequency line to equal to the pre-defined voltage (114) by adjusting a resistance of the variable resistor (106) based on an output of the comparator (110); and
applying the voltage that is regulated to the low voltage device (112).
